(19) United States
(12) Patent Application Publication
(10) Pub. No.: US 2010/0027703 A1
(43) Pub. Date: Feb. 4, 2010

(54) MULTIPLE-INPUT MULTIPLE-OUTPUT DETECTOR AND DETECTION METHOD USING THE SAME

(75) Inventors: Chun-Lin Yeh, Hsinchu City (TW); Pang-An Ting, Taichung County (TW); Jiun-Yo Lai, Taichung City (TW); Chao-Wang Huang, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Industrial Technology Research Institute, Hsinchu (TW)

(21) Appl. No.: 12/264,230

(22) Filed: Nov. 3, 2008

(30) Foreign Application Priority Data
Jul. 31, 2008 (TW) 97129102

(51) Int. Cl. H04B 7/02

(52) U.S. Cl. 375/267

(57) ABSTRACT

A multiple-input multiple-output detector and a detection method using the same are provided. The detection method includes following steps. First, a plurality of candidate results is provided by a plurality of detectors. Next, a channel condition and a detected criterion are provided. Finally, one of the candidate results is selected to serve as a detected result according to the channel condition and the selection criterion.

### CROSS-REFERENCE TO RELATED APPLICATION

This application claims the priority benefit of Taiwan application serial no. 97129102, filed on Jul. 31, 2008. The entirety of the above-mentioned patent application is hereby incorporated by reference herein and made a part of specification.

### BACKGROUND OF THE INVENTION

1. Field of the Invention

The present invention relates to a multiple-input multiple-output detector. More particularly, the present invention relates to a multiple-input multiple-output detector and a detection method using the same.

2. Description of Related Art

In a field of high-speed wireless transmission, a transmission system with a limited bandwidth requires a plenty of wireless channels to achieve the high-speed transmission. Therefore, the transmission system has to apply a plurality of transmission and receiving antennas for providing a function of multiple-input and multiple-output, so as to implement a high data rate transmission in fading channels having multi paths. Compared to a single-antenna system, the multiple-input multiple-output (MIMO) system can increase a transmission throughput without increasing of bandwidth and power.

In the MIMO system, execution results of different MIMO detectors in a wireless communication channel are different. Generally, performance of a maximum-likelihood (ML) detector is better than that of a linear detector. In case of abnormal conditions, for example, a low signal-to-noise ratio (SNR) or rank deficiency of transmission channel matrix, signals of the MIMO system cannot be normally transmitted. Therefore, the MIMO detectors have to be applied to confront losses of the signals due to being transmitted within a channel having adverse conditions, and provide diversity gains.

As described above, the MIMO system can increase the transmission throughput without increasing of the bandwidth and the power. In a spatial multiplexing technique field, the MIMO system can provide a high data rate transmission. In a downlink, a transceiver can implement data stream transmission via two or more antennas, and can receive data stream via a plurality of receiving antennas.

As to a transmitter, information and data are encoded via an encoding mechanism. For example, a viterbi algorithm or turbo codes, and the data can be transformed into a symbol via processing methods such as interpolating, interlacing or mapping, etc. Next, the transmitter multiplexedly transmits the symbol to the air via the transmission antennas. As to a receiver, after the receiver receives the data stream, the MIMO detector is applied for detecting the data.

Generally, the MIMO detector has a plurality of types, for example, the MIMO detector can be a zero-forcing (ZF) detector, a minimum mean squared error (MMSE) detector, a vertical Bell-Lab layered space-time (V-BLAST) detector, a sphere decoder (SD) or a maximum-likelihood (ML) detector.

The V-BLAST is a vertical space multiplexing detector based on linear interference suppression. In a layer selected via a high SNR, the received data is first detected. Next, the detected bit is taken as an obstacle by other data, and is removed from the remained data. Now, in the remained data, an obstacle is disappeared. Next, such processing method is repeated until all of the signals are detected.

Moreover, the ZF detector and the MMSE detector are all simple and linear detectors. To achieve a better performance, the MIMO system generally utilizes a second best detector, for example, a sphere detector. In the MIMO system, the sphere detector is a detector applying a hardware detection method, which has a performance close to that of the ML detector.

### SUMMARY OF THE INVENTION

The present invention provides a MIMO detector for detecting a data symbol to output a candidate result. The MIMO detector includes a plurality of detectors and a selection device. The detectors mutually different, and each of the detectors detects the data symbol according to a channel frequency response estimation value for outputting a corresponding candidate result. The selection device is coupled to the detectors for selecting one of the candidate results output from the detectors to serve as a detected result according to a channel condition and a selection criterion.

The present invention provides a detection method for a MIMO detector including a plurality of detectors and a selection device, wherein the detectors are mutually different. The detection method includes following steps. First, a plurality of candidate results is provided. Next, a channel condition and a selection criterion are provided. Finally, one of the candidate results is selected to serve as a detected result according to the channel condition and the selection criterion.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a transmission simulation curve diagram of two MIMO detectors.

FIG. 1B is a schematic diagram illustrating solution spaces for a plurality of MIMO detectors.

FIG. 2A is system block diagram illustrating a stacked MIMO system according to an embodiment of the present invention.

FIG. 2B is a system block diagram of a selection device of FIG. 2A.

FIG. 2C is a circuit diagram illustrating a combination calculation unit, a selection unit and a multiplexer of FIG. 2B.

FIG. 2D is a system block diagram illustrating a first embodiment of a MIMO detector of FIG. 2A.

FIG. 2E is a system block diagram illustrating a second embodiment of a MIMO detector of FIG. 2A.

FIG. 3A to FIG. 3H are simulation curve diagrams of embodiments of FIG. 2D and FIG. 2E and a conventional detector.

### DESCRIPTION OF EMBODIMENTS

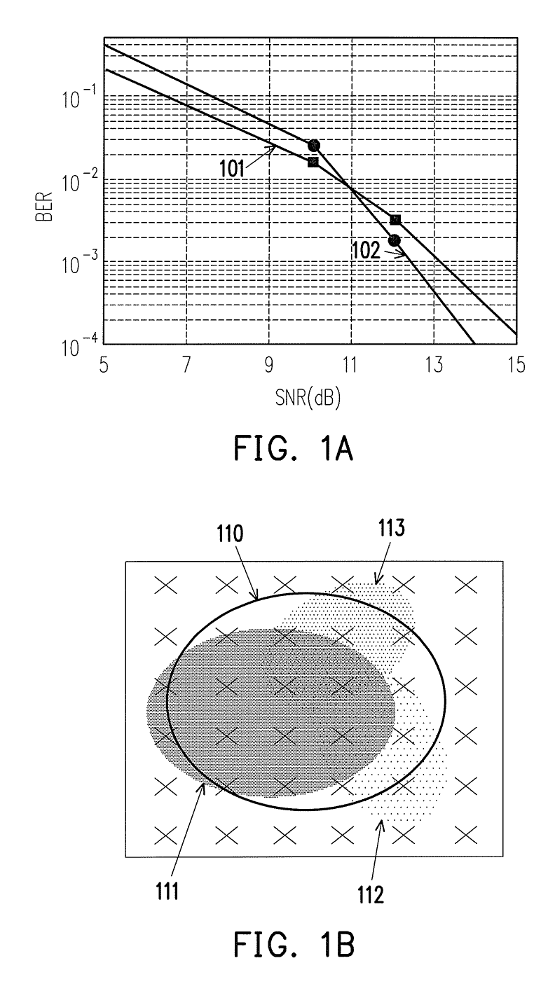

To fully convey the concept of the present invention to those skilled in the art, before embodiments of the present invention are described, basic concepts of the exemplary invention are described with reference of transmission simulation results of a plurality of MIMO detectors. FIG. 1A is a transmission simulation curve diagram of two MIMO detectors. Referring to FIG. 1A, a horizontal axis represents a signal-to-noise ratio (SNR), and a vertical axis represents bit error rates (BER), a curve 101 is the transmission simulation curve for a MMSE detector, a curve 102 is the transmission simulation curve for a V-BLAST detector. As shown in FIG. 1A, the different MIMO detectors may all have better performance as long as they are operated within suitable SNR regions thereof.

For example, in a low SNR region, a BER performance of the V-BLAST detector is better than that of the MMSE detector. Conversely, in a high SNR region, the BER performance of the MMSE detector is better than that of the V-BLAST detector. As long as the line sections having better performances are combined, namely, in the low SNR region, the V-BLAST detector is utilized, and in the high SNR region, the MMSE detector is utilized, performance of such detector combination must be better than that of the MMSE detector or the V-BLAST detector.

On the other hand, solution spaces can be utilized to explain the concept of the present invention. FIG. 1B is a schematic diagram illustrating solution spaces for a plurality of MIMO detectors. Referring to FIG. 1B, a region 110 is a solution space of a ML detector, and regions 111, 112 and 113 are respectively solution spaces of different MIMO detectors having a low complexity, for example, a ZF detector, a MMSE detector, and a V-BLAST detector. It is obvious that regions of the solution spaces covered by different MIMO detectors are also different.

As shown in FIG. 1B, the region covered by the ML detector is the greatest, though a complexity thereof is also the highest. Moreover, the ML detector is generally implemented by a sphere decoder for maintaining an optimal performance thereof, though a complexity thereof is again increased. As to the solution spaces 111-113 of other MIMO detectors, though the individual solution space thereof is relatively small, if the solution spaces of the other MIMO detectors are combined, a total region covered by the solution spaces can be increased. Namely, performance of a combination of the MIMO detectors is greatly improved. In a wireless communication system, the performance of the MIMO detectors implemented according to the aforementioned concept can be close to that of a second best detector.

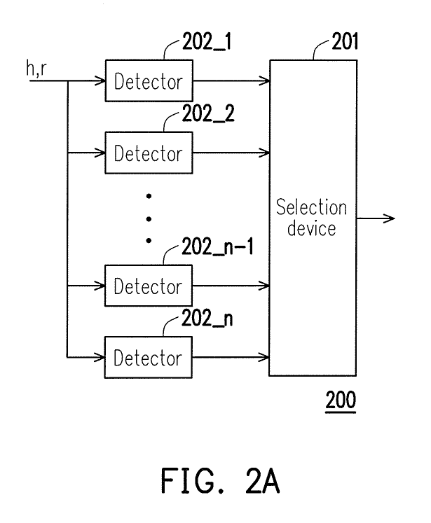

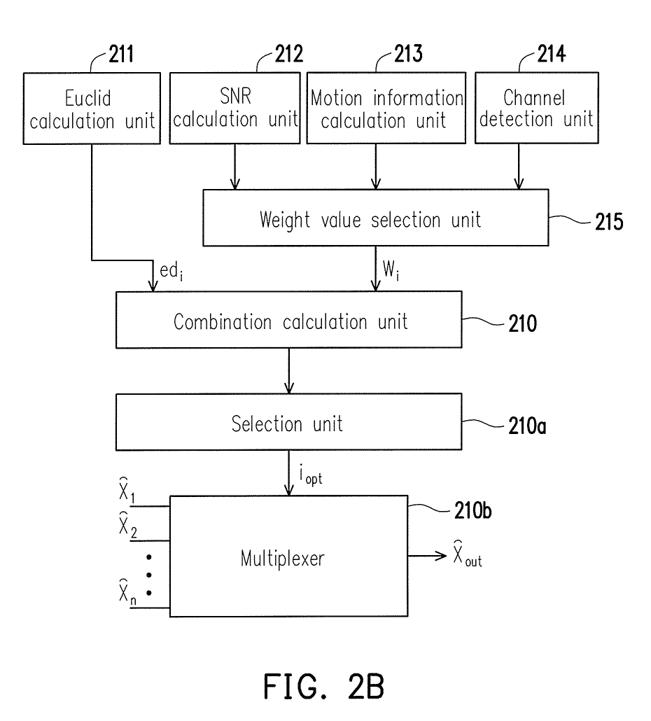

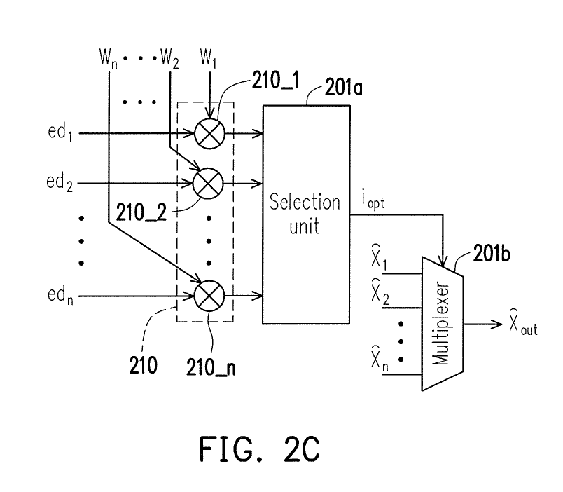

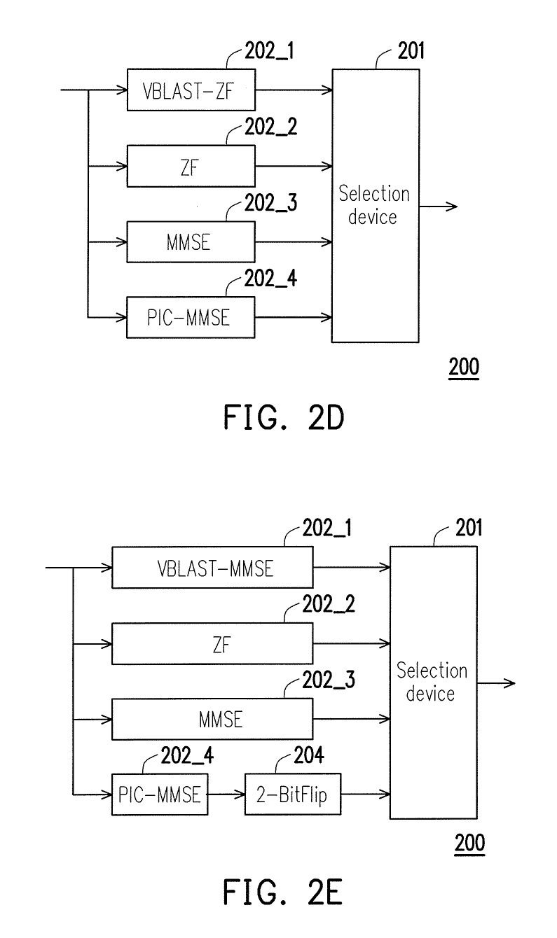

FIG. 2A is system block diagram illustrating a stacked MIMO system according to an embodiment of the exemplary invention. Referring to FIG. 2A, the stacked MIMO system 200 includes a selection device 201 and a plurality of detectors 202_1˜202_{—}n. The detectors 202_1˜202_{—}n respectively receive a channel frequency response estimation value h of a channel estimation mode and a data symbol r for detecting the data symbol r according to the channel frequency response estimation value h. The MIMO detectors 202_1-202_{—}n can be implemented by any type of the MIMO detector, such as the ZF detector, the MMSE detector, or the V-BLAST detector. After the data symbol r is detected by the MIMO detectors 202_1-202_{—}n, different candidate results are output. Then, based on a present channel condition, for example, level of the SNR, height of delay spread or level of moving speed, etc., the selection device 201 selects an optimal candidate result as a detected result, and the detected result is similar to a detected result output from the second best detector (for example, the sphere decoder). Accordingly, a plurality of diversity gains is provided, and the detected result similar to that of the second best detector can be achieved, and a complexity of such method is lower than that of the ML detector.

Further, a selection mechanism of the selection device 201 is implemented according to a selection criterion having a weight value, for example, a ML selection criterion, a minimum singular value selection criterion, a MSE selection criterion or a capacity selection criterion. Moreover, the weight value can be different under a different channel condition.

FIG. 2B is a system block diagram of a selection device of FIG. 2A. The exemplary invention is described with reference of FIG. 2A, FIG. 2B and a following equation, where the equation is an example for applying the ML selection criterion, and y represents a vector of received data, H represents a channel matrix, \hat{x}i represents the candidate results of the detectors, \hat{x}ₒᵤₜ represents the detected result, edᵢ represents distances of the detectors, wᵢ represents weight values of the detectors, and iₒₚₜ represents an exponent.

edᵢ=∥y−H\hat{x}ᵢ∥i=1, . . . , n (1)

iₒₚₜ=arg min{w₁*ed₁, w₂* ed₂, . . . , 2ₙ*edₙ} (2)

\hat{x}ₒᵤₜ=\hat{x}ᵢ_{ₒₚₜ} (3)

Referring to FIG. 2A and FIG. 2B, a SNR calculation unit 212 measures every channel SNR for providing SNR information. A motion information calculation unit 213 is for example, a gyroscope, which is used for measuring a moving speed of an environment, so as to provide motion information. A channel detection unit 214 detects a channel matrix formed in a channel scattering state to generate channel information. Next, a weight selection unit 215 generates a weight value according to a judgement of the channel condition (for example, the level of the SNR (SNR information), a moving speed (motion information) and a spread delay rate (channel information)) for selecting an optimal weight value Wᵢ, wherein i is an integer and corresponds to the MIMO detectors 202_1˜202_{—}n.

Meanwhile, a Euclid calculation unit 211 calculates distances edᵢ of the MIMO detectors 201_1-202_{—}n according to the equation (1). Next, a combination calculation unit 210 multiplies the distances edᵢ of the MIMO detectors 201_1-202_{—}n respectively with the weight values Wᵢ thereof for transmitting the multiplications to the selection unit 201a. Moreover, the selection unit 201a selects an optimal multiplication according to the equation (2), and performs an operation (for example an anti-function operation) to the optimal multiplication to obtain the exponent iₒₚₜ, wherein the optimal multiplication is for example the minimum multiplication. Finally, a multiplexer 201b outputs the detected result \hat{x}ₒᵤₜ according to the equation (3). Namely, the multiplexer 201b selects one of the candidate results \hat{x}₁-\hat{x}ₙ as the detected result \hat{x}ₒᵤₜ according to the exponent iₒₚₜ.

FIG. 2C is a circuit diagram illustrating a combination calculation unit, a selection unit and a multiplexer of FIG. 2B. Referring to FIG. 2B and FIG. 2C, the combination calculation unit 210 includes multipliers 210_1˜210_{—}n, the selection unit 201a and the multiplexer 20lb. The multipliers 210_1˜210_{—}n respectively receive the weight values W₁-Wₙ and the distances ed₁-edₙ, and respectively output the multiplications of the MIMO detector to the selection unit 201a after the multiplication operation. The selection unit 201a and the multiplexer 201b are the same to that shown in FIG. 2B, and detailed description thereof is omitted.

Two embodiments are introduced hereafter, and execution results thereof are simulated for demonstrating effects of the provided MIMO detectors. FIG. 2D is a system block diagram illustrating a first embodiment of the MIMO detector of FIG. 2A. Referring to FIG. 2D, in the exemplary embodiment, four types of the MIMO detectors are taken as an example, which are respectively a VBLAST-ZF detector 202_1, a ZF detector 202_2, a MMSE detector 202_3 and a PIC-MMSE detector 202_4. The MIMO detectors of the present embodiment further include a selection device 201.

FIG. 2E is a system block diagram illustrating a second embodiment of the MIMO detector of FIG. 2A. Referring to FIG. 2E, in the present embodiment, also four types of the MIMO detectors are taken as an example, which are respectively the VBLAST-MMSE detector 202_1, the ZF detector 202_2, the MMSE detector 202_3 and the PIC-MMSE detector 202_4. The MIMO detector of the present embodiment further includes a 2-bit bitflip 204 and the selection device 201.

The MIMO detectors of the aforementioned embodiments are all implemented via a simple method. In the following description, simulations are performed to the detectors of the aforementioned embodiments and a conventional detector, so as to demonstrate operation performances of the MIMO detectors and the conventional detector.

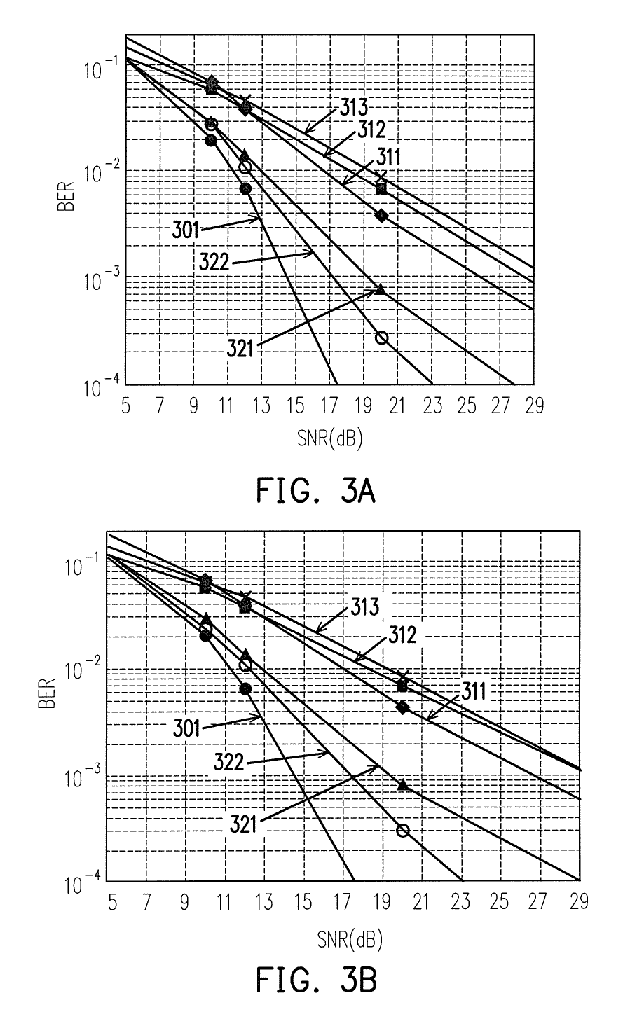

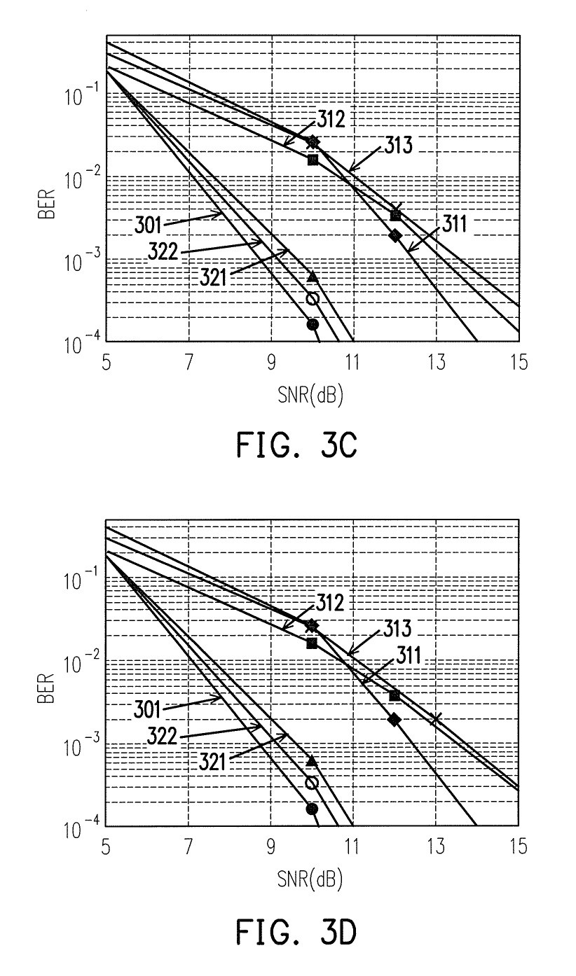

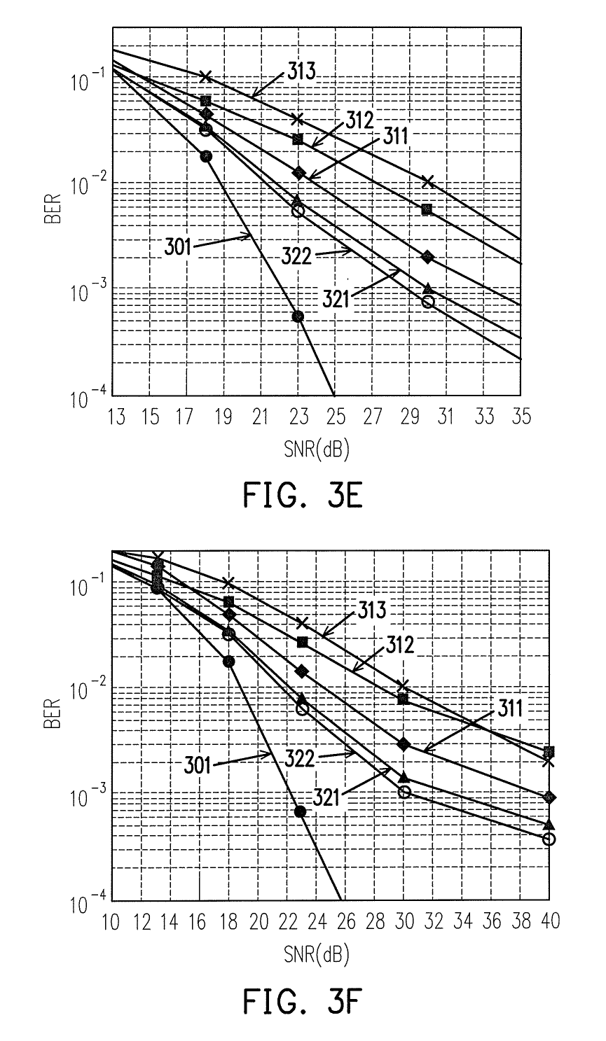

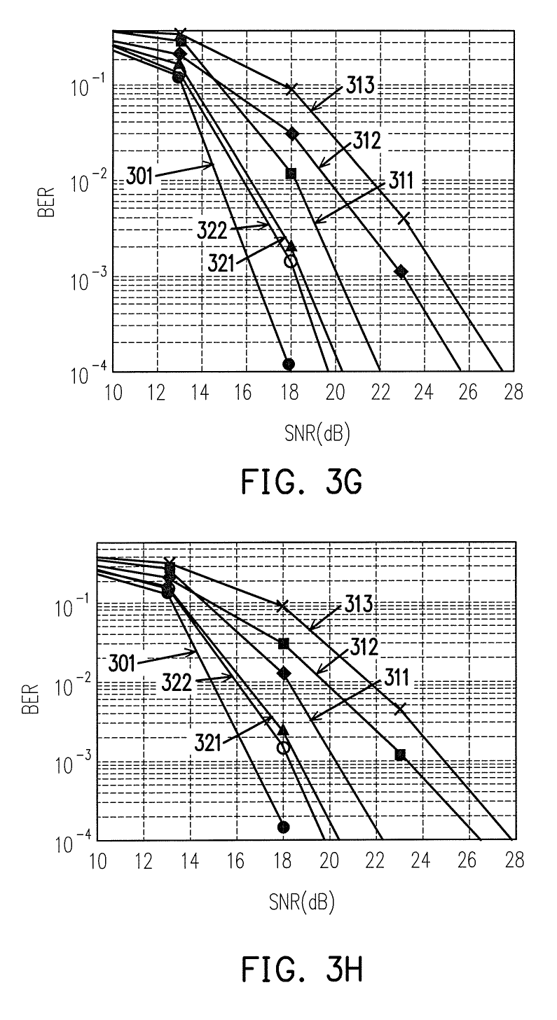

FIG. 3A to FIG. 3H are simulation curve diagrams of the embodiments of FIG. 2D and FIG. 2E and the conventional detector. Referring to FIG. 3A to FIG. 3H, horizontal axes thereof represent the SNRs, and vertical axes thereof represent BERs. A curve 301 represents a simulation result of the sphere decoder, a curve 311 represents a simulation result of the V-BLAST detector, a curve 312 represents a simulation result of the MMSE detector, a curve 313 represents a simulation result of the PIC-MMSE, a curve 321 represents a simulation result of the first embodiment, and a curve 322 represents a simulation result of the second embodiment. All of the simulations are performed under a 802.16 wireless simulation environment, and a channel mode thereof is under an environment that an international telecommunications union voice activity (ITU VA) factor has a 0-speed (VA0) and a 60 MHz-speed (VA60), and accordingly comparison results of the BERs performances of the detectors of the aforementioned embodiments and the conventional detector are obtained.

As to hardware of the simulation, a platform of simulating the 802.16e environment includes a viterbi encoder/decoder, an interleaver, a replacer/de replacer, fast Fourier transformer/inverse fast Fourier transformer, and modulator/demodulator, etc. In a 1024-ary orthogonal frequency division multiplexing (OFDM) symbol, 120-ary thereof is selected for testing. Moreover, length of a forward error correction (FEC) block is set to 288 bits. A code rate of the viterbi encoder/decoder is ½. A range of the SNR of the simulation environment is 0 dB to 40 dB, though for simplicity's sake, only a part of the range is illustrated.

First, as to a transmitter (not shown), an information block is encoded via an external error correcting coding (ECC) encoder having the ½ code rate. The encoder may apply any of ECC encoder mechanisms, for example, a viterbi algorithm, a turbo code, or a low-density parity check (LDPC) encoding, etc. An encoded stream is strengthened via replacing of the interleaver, so as to confront burst errors. An output stream of the interleaver maps to complex vectors generated based on a linear modulation mechanism. For example, the modulation mechanism includes a quadrature phase shift keying (QPSK), a 16-ary quadrature amplitude modulation (16QAM) and other modulations, wherein in the QPSK, two bits map to a complex signal, and in the 16QAM, four bits map to a complex signal. Signals are output from the modulator via a plurality of narrowband antennas. Then, through a multi-path channel in the air, the signals are received by a plurality of receiving antennas. Moreover, functions of a receiver correspond to that of the transmitter.

In the MIMO detectors referred in the aforementioned embodiments, the V-BLAST detector has an optimal performance. Therefore, the execution performance of the V-BLAST detector is taken as a comparison standard for demonstrating the simulation results.

Referring to FIG. 3A to FIG. 3D, the simulated 4×4 MIMO-OFDM systems all set a size of the fast Fourier transform to be 1024, and the modulation mechanisms thereof are all the QPSK. Referring to FIG. 3A, in case of this simulation, the speed is 0 and the encoding is not performed. In view of a horizontal line of BER 10⁻³, the first embodiment (the curve 321) having a relatively poor performance is compared to the conventional V-BLAST detector (the curve 311), and it is obvious that the BER performance of the first embodiment is better than that of the conventional V-BLAST detector, wherein an improvement extension thereof is increased by gains of 6.5 dB.

Referring to FIG. 3B, in case of this simulation, the speed is 60 and the encoding is not performed. In view of the horizontal line of BER 10⁻³, the first embodiment (the curve 321) is also compared to the conventional V-BLAST detector (the curve 311), and it is obvious that the BER performance of the first embodiment is better than that of the conventional V-BLAST detector, wherein an improvement extension thereof is also increased by gains of 6.5 dB.

Referring to FIG. 3C, in case of this simulation, the speed is 0 and the encoding is performed. Since the encoding can increase a performance of the detector, in view of the horizontal line of BER 10⁻³, the first embodiment (the curve 321) is reduced to the conventional V-BLAST detector (the curve 311), and an improvement extension thereof is increased by gains of 3 dB. Referring to FIG. 3C, in case the speed is 60 and the encoding is performed, the first embodiment (the curve 321) is also compared to the conventional V-BLAST detector (the curve 311), and an improvement extension thereof is maintained to gains of 3 dB.

Moreover, the modulation mechanism can also be the 16QAM. Referring to FIG. 3E to FIG. 3H, FIG. 3E simulates a case that the speed is 0 and the encoding is not performed, FIG. 3F simulates a case that the speed is 60 and the encoding is not performed, FIG. 3G simulates a case that the speed is 0 and the encoding is performed, and FIG. 3H simulates a case that the speed is 60 and the encoding is performed. Also in view of the horizontal line of BER 10⁻³, the performances of the aforementioned embodiments are also improved, and the gains thereof are increased by 1.5 dB. Reduction of improvement of the BER performance is due to a preferred distance of a constellation in a high modulation rate.

In summary, according to the MIMO detectors and the detection method of the present invention, the performance of the second best MIMO detector can be achieved by combining the MIMO detectors and selecting the suitable weight values. Accordingly, a whole performance of the MIMO detector can be improved without increasing of the complexity thereof. Moreover, the aforementioned embodiments can be applied to the MIMO detectors applying the IEEE 802.16e standard.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multiple-input multiple-output (MIMO) detector, for detecting a data symbol to output a detected result, the MIMO detector comprising:
a plurality of detectors, wherein each of the detectors respectively detects the data symbol according to a channel frequency response estimation value and outputs a corresponding candidate result, wherein the detectors are mutually different; and
a selection device, coupled to the detectors for selecting one of the candidate results output from the detectors as the detected result according to a channel condition and a selection criterion.

2. The MIMO detector as claimed in claim 1, wherein the selection device comprises:
an Euclid distance calculation unit, for calculating distances of the MIMO detectors according to the selection criterion;
a signal-to-noise ratio (SNR) calculation unit, for measuring every channel SNR to provide a SNR information;
a motion calculation unit, for providing a motion information;
a channel detection unit, for providing a channel information;
a weight selection unit, coupled to the SNR calculation unit, the motion calculation unit and the channel detection unit for selecting weight values of the detectors according to the SNR information, the motion information and the channel information;
a combination calculation unit, coupled to the Euclid distance calculation unit and the weight selection unit for generating a plurality of multiplications corresponding to the detectors according to the distances and the weight values;
a selection unit, coupled to the combination calculation unit, for selecting one of the multiplications according to the selection criterion and generating an exponent according to the multiplication; and
a multiplexer, coupled between the detectors and the selection unit, for selecting one of the candidate results as the detected result according to the exponent.

3. The MIMO detector as claimed in claim 2, wherein the combination calculation unit comprises:
a plurality of multipliers, wherein each of the multipliers generates a multiplication according to the corresponding distance and the weight value.

4. The MIMO detector as claimed in claim 2, wherein the distance is calculated according to an equation:
edᵢ=∥y−H\hat{x}ᵢ∥, i=1, . . . , n
wherein y represents a vector of received data, H represents a channel matrix, \hat{x}ᵢ represents the candidate results, and edᵢ represents the distances of the detectors.

5. The MIMO detector as claimed in claim 2, wherein the exponent is calculated according to an equation:
iₒₚₜ=arg min{w₁*ed₁, w₂* ed₂, . . . , wₙ*edₙ}
wherein iₒₚₜ represents the exponent, edᵢ represents the distances of the detectors, wᵢ represents the weight values of the detectors.

6. The MIMO detector as claimed in claim 1, wherein the selection criterion is a maximum-likelihood (ML) selection criterion, a minimum singular value selection criterion, a mean squared error (MSE) selection criterion, or a capacity selection criterion.

7. The MIMO detector as claimed in claim 1, wherein the channel condition comprises a delay spread speed, a SNR and a moving speed.

8. The MIMO detector as claimed in claim 1, wherein the detectors comprise a zero-forcing (ZF) detector, a minimum mean squared error (MMSE) detector and a vertical Bell-Lab layered space-time (V-BLAST) detector.

9. The MIMO detector as claimed in claim 2, wherein the motion calculation unit is a gyroscope.

10. A detection method for a MIMO detector, the MIMO detector comprising a plurality of detectors and a selection device, wherein the detectors are mutually different, the detection method comprising:
providing a plurality of candidate results;
providing a channel condition and a selection criterion; and
selecting one of the candidate results as a detected result according to the channel condition and the selection criterion.

11. The detection method as claimed in claim 10, steps of selecting one of the candidate results as the detected result according to the channel condition and the selection criterion comprise:
calculating distances of the detectors according to the selection criterion;
selecting a weight value set according to the selection criterion and the channel condition;
respectively multiplying the distance with the corresponding weight value to generate a plurality of multiplications;
selecting one of the multiplications and generating an exponent according to the multiplication; and
selecting one of the candidate results as the detected result according to the exponent.

12. The detection method as claimed in claim 10, step of providing a plurality of the candidate results comprises:
detecting a data symbol according to a channel frequency response estimation value, so as to generate the corresponding candidate result.

13. The detection method as claimed in claim 10, wherein the channel condition comprises a delay spread speed, a SNR and a moving speed.

14. The detection method as claimed in claim 10, wherein the selection criterion is a ML selection criterion, a minimum singular value selection criterion, a MSE selection criterion, or a capacity selection criterion.

15. The detection method as claimed in claim 12, wherein the delay spread speed is provided by a channel detection unit.

16. The detection method as claimed in claim 12, wherein the SNR is provided by a SNR calculation unit.

17. The detection method as claimed in claim 12, wherein the moving speed is provided by a motion calculation unit.
